(19) United States
(12) Patent Application Publication
(10) Pub. No.: US 2008/0195006 A1
(43) Pub. Date: Aug. 14, 2008

(54) MASSAGING DEVICE

(76) Inventors: Daniela Stark, Andover, MA (US); Peter Stark, Andover, MA (US)

Correspondence Address: MCCORMICK, PAULDING & HUBER LLP, CITY PLACE II, 185 ASYLUM STREET, HARTFORD, CT, 06103, US

(21) Appl. No.: 12/030,661

(22) Filed: Feb. 13, 2008

Related U.S. Application Data
(60) Provisional application No. 60/900,961, filed on Feb. 13, 2007.

(51) Int. Cl. A61H 1/00; A61H 23/00; A61H 7/00

(52) U.S. Cl. 601/46; 601/67; 601/108; 601/134

(57) ABSTRACT

A vibrating massager includes housing and clamping arms which fasten the device to the user's body. Mechanical vibrations, produced by a small electric motor spinning an eccentrically mounted weight are transmitted to the user via the arms. The device can be worn to target the areas on areas such as the shoulder that are aggravated by repetitive and extended use of a computer keyboard or mouse.

### CROSS-REFERENCE TO RELATED APPLICATIONS

This application claims the benefit of U.S. Provisional Application No. 60/900,961, filed Feb. 13, 2007, entitled “HANDS-FREE, BATTERY OPERATED, RECHARGEABLE MASSAGING DEVICE”, hereby incorporated by reference in its entirety.

### FIELD OF THE INVENTION

The present invention relates generally to massaging devices, and more particularly to a wearable massaging device which is capable of being releasably affixed to a person or a person's clothing and subsequently operated in a hands-free manner.

### BACKGROUND OF THE INVENTION

There exists many differing types of massaging devices, including chairs, beds and tables. Other wearable massaging devices are known to utilize, inter alia, straps in order to hold the massaging device against the body of a user. Typically, known massaging devices are electrically powered, via an external power source or through the use of batteries. Other known massaging devices are manually operated.

Regardless of their mode of empowerment, many known massaging devices require that a user, or other third party, physically grasp a portion of the massaging device, and continue to hold the massaging device during its operation. By so grasping the massaging device, a user or other third party can direct the movement of the massaging device, while also providing the force necessary to press a massaging surface of the massaging device against the desired portion of the body. The required pressing-force may also be realized as a function of gravity, when the user is on top of the device, such as with a massaging chair or table.

For wearable massaging devices, a lightweight design is desirable so that the user is not fatigued, however with such designs the weight of the device is typically not sufficient to produce the desired pressing-force.

Further, many people suffer from pain due to the repetitive use of a computer mouse or a keyboard, as commonly employed in typical home or office environments. This pain often occurs in the shoulder, arms and wrists. In an office environment, it is usually not possible to use a massaging chair or table while you are working. Moreover, some areas of the body are not suitable for strapping. A strap can not be used to massage the front and back of the shoulder unless the strap went around the torso or around both shoulders. Each of these configurations creates a relatively large device and significantly reduces the user's mobility.

With the forgoing problems and concerns in mind, it is the general object of the present invention to provide a massaging device that is both wearable and lightweight, but which also provides the required pressing-force between the massaging surface of the massaging device, and the body of the user. A massaging device according to the present invention can therefore be discreetly utilized in a preventive and palliative fashion in an office environment.

### SUMMARY OF THE INVENTION

It is one object of the present invention to provide a wearable massaging device.

It is another object of the present invention to provide a wearable massaging device that may be operated in a hands-free manner.

It is another object of the present invention to provide a wearable massaging device that can be selectively and releasably affixed to a person's body or clothing.

It is another object of the present invention to provide a wearable massaging device that can be selectively and releasably affixed to a person's body or clothing via a spring biased, or resiliently-elastic, member.

It is another object of the present invention to provide a wearable massaging device which may be either battery-powered, or powered through external (AC/DC) power input.

The present invention is therefore generally directed at a massaging device that is attachable to the shoulder or arm via a spring or clamp (plastics are one embodiment however other materials, metals, composites, etc that provide an elastic or spring force may also used) that relieves muscle and join pain caused by repetitive motion or other activities which strain the arm muscles or joints. The massaging device may or may not be augmented with a retaining device such as a thin elastic strap that is adjustable for comfort and that could be used to secure the device on the place where the user deems its action efficacious. The massaging device (i.e., hereinafter the “massager”) can also be secured by clipping it on the clothes of the user. Ideally, the device can be put on with one hand and can be worn over clothes allowing the user to continue the desired activity with minimal interruption. Other embodiments also exist in which the device requires more than a single hand for mounting.

Attached to the spring, described above, is another device that provides vibration. The frequency of this vibration is from 0.1 to 1000 Hz. The amplitude of the vibration is such that it provides subtle to pleasant stimulation of the area to which it is applied. The force is on the order of 1 to 1000 N. In one embodiment, the vibration is created by a mass on a DC motor. This mass center is located eccentric to the axis of the motor shaft. Frequency of the vibration of this embodiment is adjusted through varied resistance from the power source (in this case, a battery) to the motor. There exist other embodiments in which the vibration is provided by other means such as solenoids or cams. The attachment of the vibratory source is to the spring should be damped as little as possible. This provides the most efficient transfer of power from the vibratory source to the spring or clamp. It is also desirable to have as little damping as possible between the user and the attachment (the spring or clamp). This method not only provides highly efficient power transfer but also allows distribution of the vibratory force to a large area (decreasing the pressure of a single or small point while allowing multiple directions of the action of vibration.)

It is preferential to have the source of the vibratory power (the battery) be rechargeable on the device via a small plug. This allows the device to be sealed from ingress of contaminants and maintains a small package. However, it may be deemed cost on convenience efficacious to have direct power input (AC or DC) via a plug or to have removable batteries. A super capacitor is also an option.

These and other objectives of the present invention, and their preferred embodiments, shall become clear by consideration of the specification, claims and drawings taken as a whole.

### BRIEF DESCRIPTION OF THE DRAWINGS

FIG. 1 is a front view of a massager showing it worn on the shoulder of a user, according a preferred embodiment of the present invention.

FIG. 2 is an isometric view of the massager, according to a preferred embodiment of the present invention.

FIG. 3 is side view of the massager, according to an alternative embodiment of the present invention.

FIG. 4 is front view of the massager, according to a preferred embodiment of the present invention.

FIG. 5 is side view of the massager, according to a preferred embodiment of the present invention.

FIG. 6 is top view of the massager, according to a preferred embodiment of the present invention.

FIG. 7 illustrates the inside of the arms of the massager, according to a preferred embodiment of the present invention.

FIG. 8 illustrates a side view of the end of on of the arms of the massager, according to a preferred embodiment of the present invention.

FIG. 9 illustrates an exploded view of the massager, according to a preferred embodiment of the present invention.

FIG. 10 is an isometric view of a motor with an eccentrically mounted weight.

### DETAILED DESCRIPTION OF THE PREFERRED EMBODIMENT

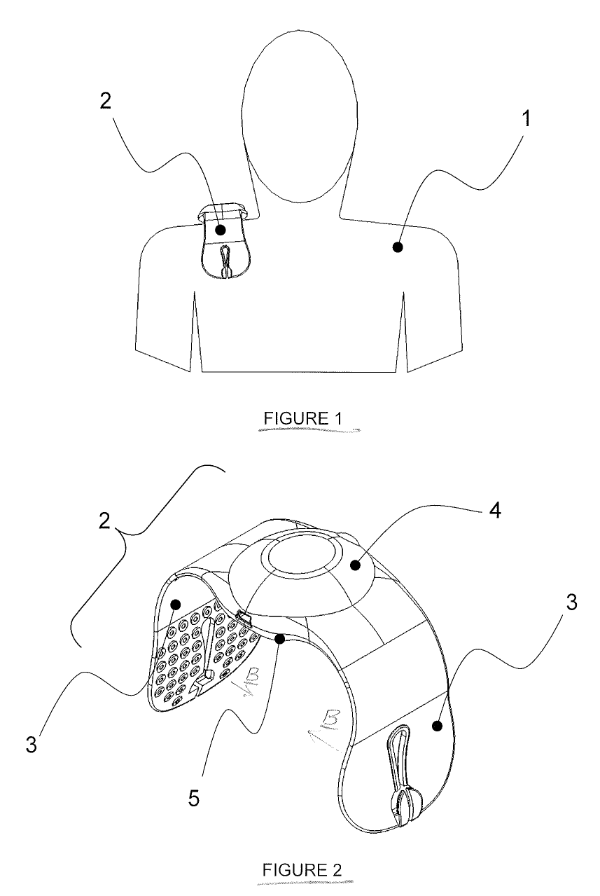

FIG. 1 shows a user 1 wearing a massager 2, according to one embodiment of the present invention. As shown in FIG. 1, the massager 2 is selectively and releasably disposed upon the shoulder area of the user 1, in order to relieve pain in the shoulder area which often develops when using, e.g., a computer mouse or keyboard for extended periods of time.

As will be discussed in more detail later, it will be readily appreciated that although the massager 2 is shown as being affixed to the shoulder area of a user, the present invention is not so limited in this regard. Indeed, the present invention envisions that the massager 2 may be releasably affixed to any portion of the body, without departing from the broader aspects of the present invention.

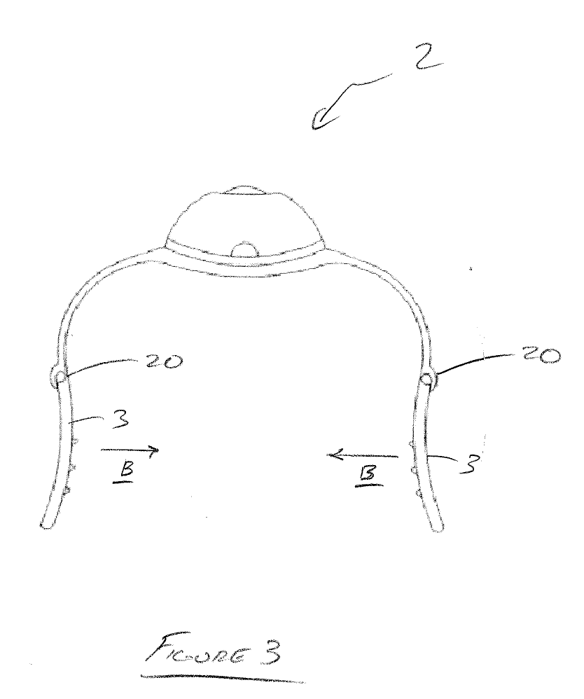

FIG. 2 shows an isometric view of the massager 2. As shown in FIG. 2, the massager includes a pair of clamp arms 3 which are preferably rigidly fixed to the upper housing 4 and the lower housing 5. The clamp arms 3 may be manufactured from a flexible polymer such as polypropylene, although other suitable, resiliently elastic materials may be alternatively utilized.

It is therefore an important aspect of the present invention that the clamp arms 3 are formed such that their distal ends are angled slightly towards one another, as shown by biasing arrow B in FIG. 2. The resiliently elastic material of the clamp arms 3 can therefore be selectively deformed outwardly from one another when the massager 2 is slipped on or over an effected body part, such as the shoulder area as shown in FIG. 1. In such cases, the deformation of the clamp arms 3 creates an inherent bias in the material of the clamp arms 3 such that the clamp arms 3 are biased towards one another and thereby exert a clamping force upon any body portion disposed therebetween.

While the clamping arms 3 have been described as having their distal ends being angled towards one another, the present invention is not so limited in this regard. Indeed, by forming the clamping arms 3 from resiliently elastic materials, it is indeed possible to orient the clamping arms 3 parallel to one another, or even, alternatively, with their distal ends being angled away from one another. It will therefore be readily appreciated that regardless of the relative angle of inclination between the opposing clamping arms 3, when the distal ends of the clamping arms 3 are pulled away from one another (such as to place a body part therebetween), an inherent bias is created in the material of the clamping arms 3 such that the clamping arms 3 are biased towards one another and thereby exert a clamping force upon any body portion disposed therebetween

It will also be readily appreciated that the massager 2 of the present invention can be selectively and releasably affixed to any portion of a user's body, whereby the clamp arms 3 are inherently configured to capture the body portion therebetween, and thus hold the massager 2 against the body portion during operation of the massager 2.

As shown in FIGS. 1 and 2, it is therefore another important aspect of the present invention that the massager 2 may be releasably affixed to an affected body portion without the need for any straps, locks, or the like. Moreover, once the massager 2 is placed in its desired position on a body portion, it will be readily appreciated that the massager 2 is capable of maintaining its position without the need for the user to continue holding the massager 2. Thus, the massager 2 of the present invention provides a wearable massage device which may be releasably affixed to a body portion and whose operation is not dependant upon the user holding or manually securing the massager 2 during operation.

Although FIG. 2 illustrates the clamp arms 3 as being integral members connected to the upper and lower housings, 4 and 5 respectively, the present invention is not so limited in this regard. In alternative embodiments, the clamping arms 3 may instead employ a mechanical and spring biased hinge 20 so as to actively bias the opposing arms 3 towards one another, as shown in the alternative embodiment of FIG. 3. In addition to providing the required biasing force, the hinges 20 permit the massager 2 to fold up into a more compact form for storage, similar to eye glasses. In still other embodiments, rigid materials are used with hinges and springs to create a clamping force between the arms and around the body.

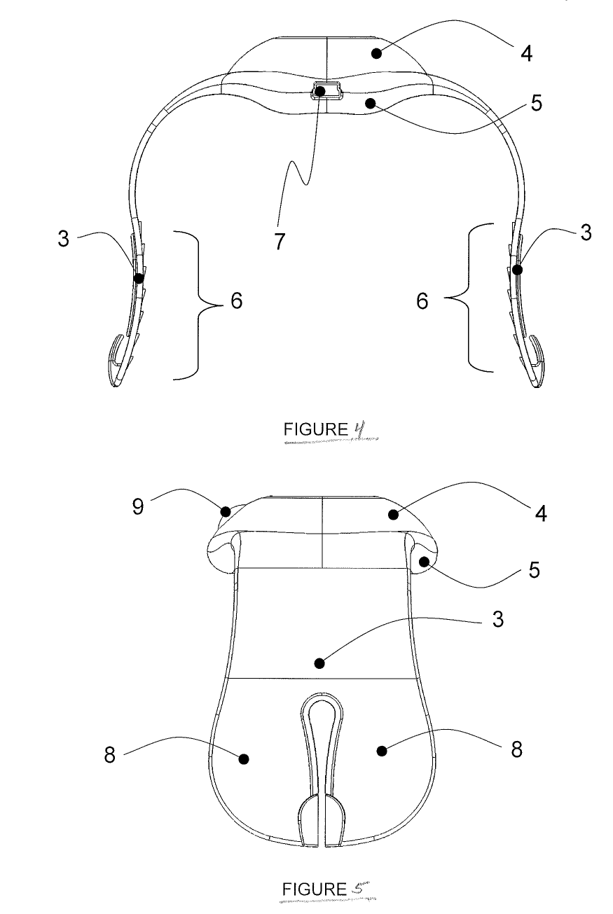

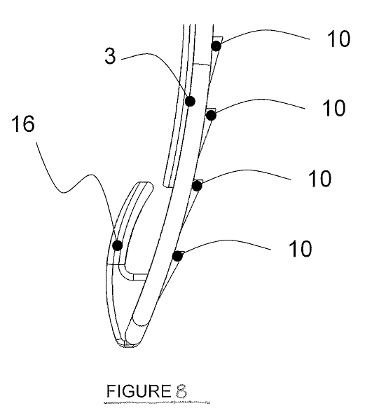

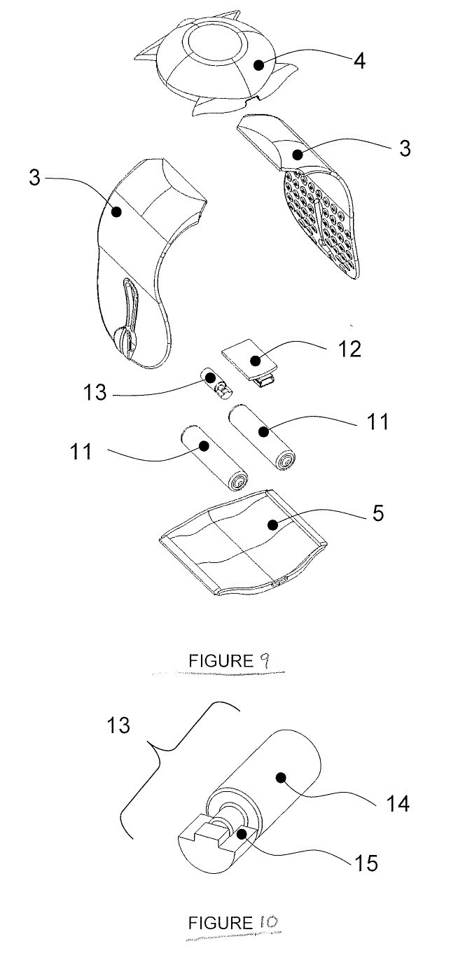

Returning now to FIG. 4, a front view of the massager 2 of FIGS. 1 and 2 is shown. As will be described in more detail in connection with FIG. 7, each of the clamp arms 3 exhibit an inner friction surface 6 that assists in improving the holding force of the massager 2 on the user. An electrical charging port 7 is also provided, for accepting mini USB cable plugs or the like, and may be utilized to selectively charge the rechargeable batteries stored within the housing 4/5 of the massager 2. Other charging ports, in other locations and electrical configurations, are also alternatively envisioned.

FIG. 5 shows a side view of the massager 2. As shown in FIG. 5, each of the arms 3 has two, distal fingers 8. Because the arms 3 are preferably made of polymeric materials, each flexes to conform to the surface of the body portion to which they are in contact. It will be readily appreciated that as fingers 8 flex, they more evenly distribute the clamping force to the surface of the user's body, improving both the comfort and secure fit of the massager 2. While a pair of fingers 8 have been shown at the distal end of each of the clamp arms 3, it will be appreciated that any number of separate fingers 8 may be defined on the arms 3 without departing from the broader aspects of the present invention.

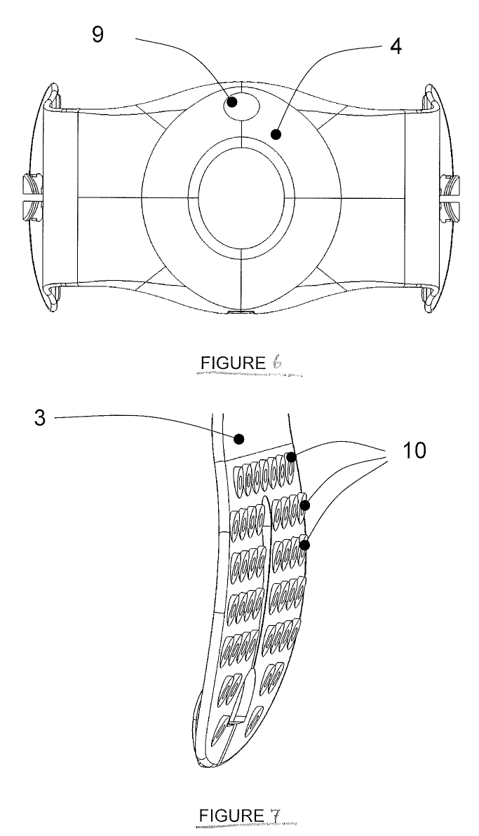

FIG. 6 shows a top view of the device. A push button 9 allows the user to control the function of the device. The function can include several modes. Modes envisioned include: off, constant vibration and varying vibration. When the vibration is varying, the frequency and amplitude may approximate the major frequency of a cat's purr.

FIG. 7 shows a detailed view of the inside of an arm 3. The friction surface 6 consists of a series of repeating friction features 10. As shown in FIG. 7, the friction features 10 are preferably ring shaped protrusions with slanted tops to create a saw tooth profile. As will be appreciated, when the massager 2 is pushed down upon a body portion, the inclined surface of the friction features 10 permit the arms 3 to slide easily over the captured body portion. As will also be appreciated, the inclined nature of the friction features 10 also has the effect of impeding the removal of the massager 2 from the captured body portion, absent an outside biasing force being applied to separate the opposing arms 3.

While saw-toothed friction features 10 have been shown in FIG. 7, other friction surfaces are envisioned including surfaces with other geometry or made of a different material than the arms 3. The friction surface material could be made of a material with a higher coefficient of friction than the arms 3, thereby improving the holding force of the massager 2 on the wearer's body/clothes.

FIG. 8 shows a detailed side view of the end of the arm 3. As discussed, the saw tooth profile of the friction feature 10 is configured to allow the device to easily slide onto the user's clothes/body, and to maintain its position once the massager 2 has been so placed. A hook 16 is included adjacent the distal end of each of the clamp arms 3 to facilitate the use of an adjustable elastomeric cord. The cord can be used to further maintain the position of the device, and to increase the inward bias of the arms 3 towards one another, as desired.

FIG. 9 is an exploded view of the massager 2. The upper housing 4 and the lower housing 5 are assembled via screws or other means to capture, in total, the arms 3, a rechargeable power source 11, a circuit board 12 and a motor assembly 13 with an eccentric weight. The circuit board 12 includes a control algorithm, or the like, to control the motor assembly 13 via operation of the push button 9 and as powered by the rechargeable power source 11. The control algorithm of the circuit board 12 also regulates the recharging of the power source 11 when power is applied to the recharge port 7. The rechargeable power source 11 can be two AAA NiCad batteries or other rechargeable or replaceable power source such as a standard non rechargeable battery. The circuit board 12 may also have the ability to run the device directly from the recharge port 7.

FIG. 10 shows a motor assembly 13 with an eccentric weight attached. The motor housing 14 includes a motor shaft extending from one end. The eccentric weight 15 is mounted to the motor shaft. As will be appreciated, as the motor rotates about its shaft-axis, the eccentric weight 15 is caused to repeatedly and sporadically contact the inside of the lower housing 5, which will be in touching contact with a body portion. Thus, the eccentric weight 15 and associated motor assembly 13 define an active massaging element that may be selectively energized via actuation of the power/push button 9.

While an eccentrically disposed weight 15 has been shown and described in connection with FIGS. 9 and 10, the present invention is not so limited in this regard. That is, any alternative active massaging element or assembly may be enclosed within the upper and lower housings, 4 and 5, without departing from the broader aspects of the present invention.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling within the scope of the appended claims.

What is claimed is:

1. A massage apparatus, comprising:
a central housing;
an active massaging element disposed with said central housing;
a pair of clamping arms extending from said central housing; and
wherein said clamping arms are formed from elastic material.

2. The massage apparatus according to claim 1, wherein:
said clamping arms define two fingers adjacent a distal end thereof.

3. The massage apparatus according to claim 1, wherein:
said clamping arms include a friction surface having a friction feature extending outwardly therefrom.

4. The massage apparatus according to claim 1, wherein:
said clamping arms define hooks adjacent a distal end thereof.

5. The massage apparatus according to claim 1, further comprising:
a rechargeable power source.

6. The massage apparatus according to claim 1, wherein:
said active massaging element includes a weight that is eccentrically mounted to a shaft of a motor.

7. The massage apparatus according to claim 1, wherein:
said pair of clamping arms include a hinge, said hinge being spring biased.

8. The massage apparatus according to claim 1, further comprising:
a control circuit in electrical communication with said active massaging element; and
wherein said control circuit is capable of selectively altering the operating frequency of said active massaging element.

9. The massage apparatus according to claim 8, wherein:
said operating frequency is between 0.1 to 1000 Hz.

10. A massage apparatus, comprising:
a hub;
a massaging element;
a pair of clamping arms extending from said hub; and
wherein said clamping arms are formed from a resilient material such that a clamping force is created between said clamping arms when a distal ends of said clamping arms are moved away from one another.

11. The massage apparatus according to claim 10, wherein:
said clamping arms define two fingers adjacent a distal end thereof.

12. The massage apparatus according to claim 10, wherein:
said clamping arms include a friction surface having a friction feature extending outwardly therefrom.

13. The massage apparatus according to claim 10, wherein:
said clamping arms define hooks adjacent a distal end thereof.

14. The massage apparatus according to claim 10, further comprising:
a rechargeable power source.

15. The massage apparatus according to claim 10, wherein:
said distal ends of said clamping arms are oriented at an angle towards one another.

16. The massage apparatus according to claim 10, wherein:
said massaging element includes a weight that is eccentrically mounted to a shaft of a motor.

17. The massage apparatus according to claim 10, wherein:
said pair of clamping arms include a hinge, said hinge being spring biased.

18. The massage apparatus according to claim 10, further comprising:
a control circuit in electrical communication with said massaging element; and
wherein said control circuit is capable of selectively altering the operating frequency of said massaging element.

19. The massage apparatus according to claim 18, wherein:
said operating frequency is between 0.1 to 1000 Hz.
